(19) United States
(12) Patent Application Publication
(10) Pub. No.: US 2017/0284563 A1
(43) Pub. Date: Oct. 5, 2017

(54) COMPRESSION LIMITER TO ACCOMMODATE THERMAL EXPANSION DIFFERENTIAL

(71) Applicant: Schaeffler Technologies AG & Co. KG, Herzogenaurach (DE)

(72) Inventors: Zheng Lou, Plymouth, MI (US); Vineeth Jampala, Troy, MI (US); Brett Allossery, Bloomfield Hills, MI (US)

(73) Assignee: Schaeffler Technologies AG & Co. KG, Herzogenaurach (DE)

(21) Appl. No.: 15/088,189

(22) Filed: Apr. 1, 2016

(51) Int. Cl. F16K 51/00; F16K 27/00

(52) U.S. Cl. CPC F16K 51/00; F16K 27/00; F16H 57/0434

(57) ABSTRACT

A coolant valve mounting arrangement is provided for a vibrating environment with significant temperature fluctuations. The mounting arrangement includes a fastener, a housing, a compression limiter and a mounting base. The compression limiter is arranged to minimize the housing thickness in order to reduce subsequent thermal expansion effects, while maintaining packaging, stiffness and strength requirements. A spring washer can be implemented to ensure that an adequate force is applied to the housing to maintain the integrity of a leak-free interface with the mounting base.

### BACKGROUND

The present invention relates to a mounting arrangement, and more particularly, to the mounting arrangement of a coolant valve to a mounting base within a vibrating, variable temperature environment.

As fuel economy becomes paramount in the transportation industry, efforts have increased to achieve higher internal combustion engine efficiencies and to seek alternative powertrains Coolant valve assemblies are well known and can be arranged to provide coolant flow control for temperature management of various powertrain components including internal combustion engines, transmissions and various components of hybrid electric and fuel cell vehicles.

One prong of the quest for improved fuel economy includes lightweighting. Significant strides have been made in the material sector to provide metal alternatives that not only offer significant weight savings, but also potential improvements in performance and cost. Management of the inherent properties of these lightweight materials is especially vital in intense environments offered by the powertrains and drivetrains of current and future vehicles.

The design of an engine component to function for many years and miles on the exterior of an internal combustion engine, while maintaining multiple leak-free seals offers several challenges, especially for electronic components. These challenges include vibrational loading, substantial temperature fluctuations, water invasion and immersion, engine fluid exposure, along with elbow loads from mechanics during times of maintenance.

The aforementioned challenges are further exacerbated by the packaging requirements. With the onset of new technologies and trends such as turbocharging and noise abatement, to name a few, the available space on and around the engine is highly sought after in the powertrain world. In addition, tool clearances for fastening the component to the engine in a crowded environment can also affect the design. An engine component of considerable size that resides on the outside of the engine and needs to interface with multiple components is likely to undergo several modifications to package properly within the engine compartment.

The aforementioned demands apply to an electronic coolant valve, typically a plastic component within a pressurized ethylene glycol coolant system, required to function without failure and maintain a leak-free seal with the engine or other vehicle mounting base over the lifetime of the vehicle.

The use of a plastic material requires management of its inherent thermal properties. Most plastic materials contain higher coefficients of thermal expansion than metals, meaning that the size of a plastic component will change more than a metal component of equivalent size when subject to the same temperature change. The magnitude of linear thermal expansion is calculated from the following formula:

Δh=h₀αΔT
where:
   Δh=change in height
   h₀=original height
   α=coefficient of thermal expansion
   ΔT=change in temperature

The magnitude of the thickness or height of the housing is one of the factors that influences its change in height due to a change in temperature. This change in height is further pronounced with most plastic materials that possess a high coefficient of thermal expansion. It should be understood that the change in height can be positive or negative, for increasing or decreasing temperatures, respectively.

Referring to FIG. 1A, a cross-sectional view of a prior art coolant valve mounting arrangement 100 is shown that contains a fastener 102, a housing 104, a compression limiter 106, and a mounting base 108. In this arrangement, the housing 104 spans the entire length of compression limiter 106, shown as distance h_{PO}±x₂ in FIG. 1B. Packaging a coolant valve, often cylindrical in form, on the engine often requires it to be offset from the engine; in some instances, distance h_{PO} can be 100 mm or more. This large magnitude of housing height at the mounting location yields large fluctuations in size due to thermal expansion which result in stresses within the mounting structure of the coolant valve. A solution is required to reduce the housing height within the mounting arrangement, yet maintain the strength, stiffness and packaging requirements dictated by the engine application.

An additional challenge resides in maintaining the coolant valve's leak-free seal with the engine. Referring again to FIG. 1B, given the manufacturing variation in height h_{PO}±x₂ of the housing 104 and the manufacturing variation in height S±x₁ of the compression limiter 106, a distance dL₁ represents the difference in these two heights. Typically, this distance dL₁ can be positive or negative. A positive distance represents a condition where the compression limiter height S is taller than the housing height h_{PO}. This condition is shown in FIG. 1B. A negative distance represents a condition where the compression limiter height S is shorter than the housing height h_{PO}, such that the housing extends beyond the limiter. Distance dL₁ must be designed to prevent an excessive negative clearance which could result in either of two scenarios: a high stress condition could result due to excessive compression of the plastic housing required for the fastener to contact the top of the compression limiter during the torquing process; or, if the fastener only contacts the housing and not the limiter after the torquing process, plastic creep could occur over time, possibly resulting in a loosening of the joint. In addition to manufacturing tolerances, temperature of the respective mounting arrangement components also affects the distance dL₁. Applying the aforementioned formula for thermal expansion, one can understand that as housing thickness increases, the effect on the distance dL₁ caused by the housing also increases. Furthermore, an excessive positive dL₁ clearance can potentially result in excessive movement of the housing within the mounting joint, especially at cold temperatures, which can be a detriment to maintaining a leak-free seal with the mounting base. In typical applications, the distance dL₁ is designed where the greatest negative clearance (housing protrusion beyond the limiter) will allow for compression of the housing within the stress limits of the material until the limiter is contacted by the torqued fastener. However, due to typical tolerances of the housing thickness and compression limiter, this design scenario usually requires that distance dL₁ is biased towards a positive clearance. A solution is required to eliminate or reduce the risk of coolant valve seal leakage during a positive distance dL₁ condition.

### SUMMARY

A coolant valve mounting arrangement for a vibrating environment with large temperature fluctuations is provided. The arrangement includes a housing, a mounting base, a compression limiter, and a fastener. The compression limiter contains a shelf along its length to support one side of the housing of a thickness that is less than the length of the limiter. The compression limiter can be formed from various processes such as machining, powder metallurgy, metal injection molding, drawing or forging. In another aspect, a washer can be installed on the compression limiter shelf to increase the amount of support area with the housing. The fastener extends through a through hole of the compression limiter and attaches the compression limiter to the mounting base. The fastener can include an integral flange or separate washer component for optimum clamping of the mounting arrangement. The housing is preferably made of plastic, which can be over-molded on the compression limiter, but can also be made of different metals. The mounting base can contain a recessed opening to receive the compression limiter. The shape of the compression limiter can be round for ease of manufacturing. In another aspect of the compression limiter, a male component can be inserted into a female component to form the shelf that supports the housing. The male component can contain a through slit along its length to provide for an elastic characteristic to aid in the assembly process of the two components. In yet another aspect of the compression limiter, one upper element can abut against a lower element to form the shelf that supports the housing.

Either of the aforementioned coolant valve mounting arrangements can include a spring washer and support washer combination placed between the fastener and the housing. The presence of the spring washer can ensure that a sealing force is applied to the housing under all manufacturing tolerance and operating temperature conditions. It is possible that the fastener clamp load on the housing can be reduced due to sizing of the housing with respect to the compression limiter; this condition can be magnified at cold operating conditions when the housing, potentially made from a material with a high coefficient of thermal expansion such as plastic, reduces in height more than the compression limiter subjected to the same cold temperature. In a cold operating condition, the effective height of the spring washer would be greater than in a hot operating condition due to the resultant thickness variation of the housing. Different types of spring washers can be used including split type, Belleville type or wave type. The presence of the support washer ensures that the spring washer can function as intended without harming, deforming or inducing unwanted stresses in the housing.

In another embodiment, a compression limiter shelf supports a second side of the housing. The fastener applies a clamp load to the compression limiter and couples it to the housing. A spring washer and supporting washer arrangement is possible between the compression limiter shelf and second side of the housing.

### BRIEF DESCRIPTION OF THE DRAWINGS

The foregoing Summary as well as the following Detailed Description will be best understood when read in conjunction with the appended drawings. In the drawings:

FIG. 1A is a cross-sectional view of a prior art coolant valve mounting arrangement.

FIG. 1B is a detailed view taken from FIG. 1A.

FIG. 2 is a cross-sectional view of a first embodiment of a coolant valve mounting arrangement.

FIG. 3 is a cross-sectional view of a first variation of the coolant valve mounting arrangement of FIG. 2.

FIG. 4 is a cross-sectional view of a second variation of the coolant valve mounting arrangement of FIG. 2.

FIG. 5 is a cross-sectional view of a third variation of the coolant valve mounting arrangement of FIG. 2.

FIGS. 5A and 5B are a perspective view and a cross-sectional view of a compression limiter component of FIG. 5.

FIG. 6 is a cross-sectional view of a fourth variation of the coolant valve mounting arrangement of FIG. 2.

FIGS. 6A and 6B are detailed views taken from FIG. 6.

FIG. 7 is a cross-sectional view of a fifth variation of the coolant valve mounting arrangement of FIG. 2.

FIG. 8 is a cross-sectional view of a second embodiment of a coolant valve mounting arrangement.

FIG. 9 is a cross-sectional view of a first variation of the coolant valve mounting arrangement of FIG. 8.

FIG. 10 is a cross-sectional view of a portion of a coolant valve housing and a mounting base.

### DETAILED DESCRIPTION OF THE PREFERRED EMBODIMENTS

Certain terminology is used in the following description for convenience only and is not limiting. The words “inner,” “outer,” “inwardly,” and “outwardly” refer to directions towards and away from the parts referenced in the drawings. A reference to a list of items that are cited as “at least one of a, b, or c” (where a, b, and c represent the items being listed) means any single one of the items a, b, c or combinations thereof. The terminology includes the words specifically noted above, derivatives thereof, and words of similar import.

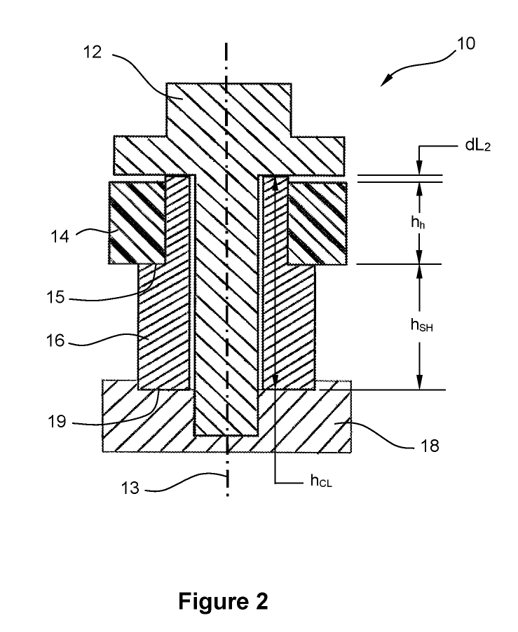

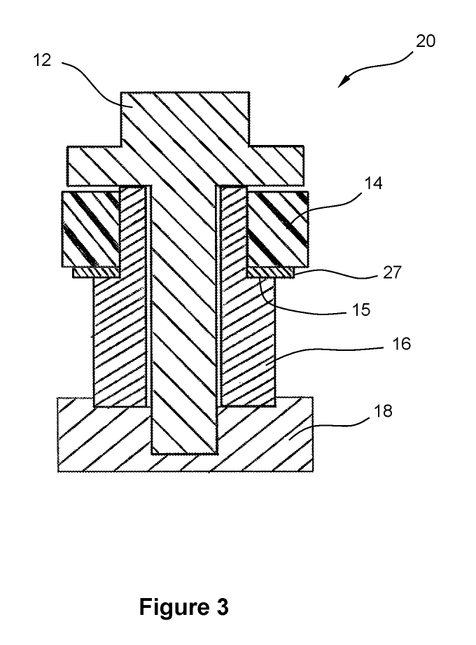

Referring to FIG. 2, a first embodiment of a coolant valve mounting arrangement 10 is shown that includes a fastener 12, a housing 14 of the coolant valve with a height hₕ, a compression limiter 16 with a height h_{CL}, a mounting base 18 and a central axis 13. The compression limiter 16 has an upper or first portion with an outer surface that is disposed within a through aperture of the housing 14. The housing 14 can retain the first portion of the compression limiter 16 by means of an interference fit, or, if a plastic is used for the material of the housing 14, the housing 14 can be over-molded on the first portion of the compression limiter 16. The compression limiter 16 contains a second portion with a first side in the form of a shelf 15 located at a medial position on the compression limiter 16 at a height h_{SH} to support the housing 14. The through aperture of the housing 14 is axially aligned with a through aperture or hole of the compression limiter 16. The fastener 12 extends through the through aperture of hole of the compression limiter 16 and attaches to the mounting base 18. The form of the compression limiter 16 can be of any shape, with the option of it being round for ease of manufacturing. In order to minimize thermal expansion of the housing 14 and subsequent stresses, a height hₕ of the housing 14 can be significantly smaller than the height h_{CL} of the compression limiter 16, due to the presence of the shelf 15 or its height h_{SH}. The preferred material of the compression limiter 16 is metal and its form, including the shelf 15, can be achieved by any metal removal or metal forming processes such as machining, drawing, powder metallurgy, metal injection molding, or forging. The mounting base 18 optionally includes a recess 19 for guiding or seating the compression limiter 16. A generous size of such a recess 19 would be required to account for positional and size tolerances.

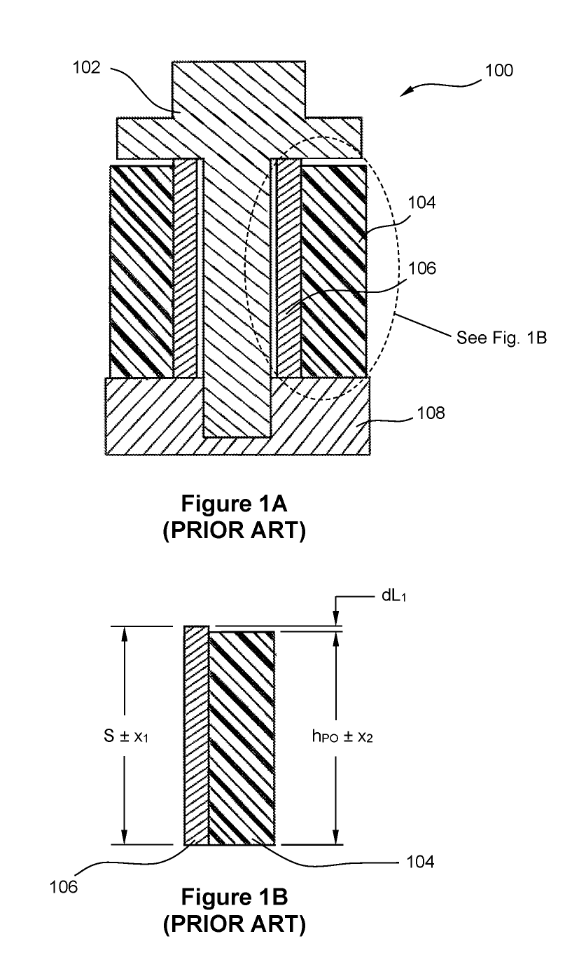

Now referencing FIG. 1's prior art coolant valve mounting arrangement 100 with a fastener 102, a housing 104 with a height h_{PO}, a compression limiter 106 with a height S, and a mounting base 108, one can observe that the magnitude of housing 104 height h_{PO} is larger than the magnitude of the housing 14 height hₕ of FIG. 2's coolant valve mounting arrangement 10. Due to this difference in housing height magnitude, the thermal expansion of the housing 104 of the prior art coolant valve mounting arrangement 100 exceeds the thermal expansion of the housing 14 of FIG. 2's coolant valve mounting arrangement 10. Therefore, the resultant thermal stresses in the housing 14 of the coolant valve mounting arrangement 10 are likely lower than the resultant thermal stresses in the housing 104 of the coolant valve mounting arrangement 100. Furthermore, this improvement can be further illustrated by a shown distance dL₂ in FIG. 2, which represents the distance in height between the top of the housing 14 and the top of the compression limiter 16. The distance dL₂ is affected by the manufacturing tolerances of the compression limiter 16 and the housing 14 in addition to temperature and resultant thermal expansion effects. Comparing FIG. 2's coolant valve mounting arrangement 10 to FIG. 1's prior art coolant valve mounting arrangement 100, one can observe that the distance dL₂ is less sensitive to temperature of the coolant valve mounting arrangement than dL₁ due to the difference in housing 14, 104 heights hₕ, h_{PO}.

Referring now to FIGS. 3-7, multiple variations of the first embodiment of the mounting arrangement 10 provided in FIG. 2 are shown that will also result in a lower thermal stress condition than the prior art coolant valve mounting arrangement 100 shown in FIG. 1A.

FIG. 3 shows a coolant valve mounting arrangement 20 with a washer 27 that can be installed on the compression limiter shelf 15 in order to increase the support area beyond that provided by the shelf 15 and reduce the contact stress and thus the potential for material deformation of the housing 14.

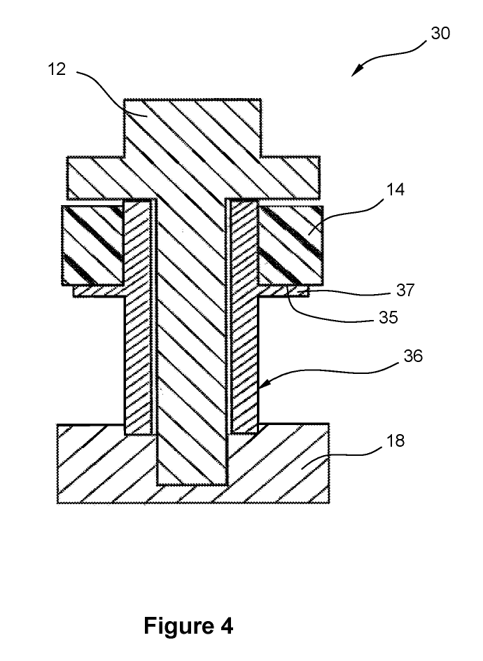

FIG. 4 shows a coolant valve mounting arrangement 30 with a compression limiter 36 that has an integral flange 37 to provide a shelf 35 for support of the housing 14. The compression limiter 36 can be formed by various metal-forming processes such as machining, drawing, powder metallurgy, metal injection molding, and forging.

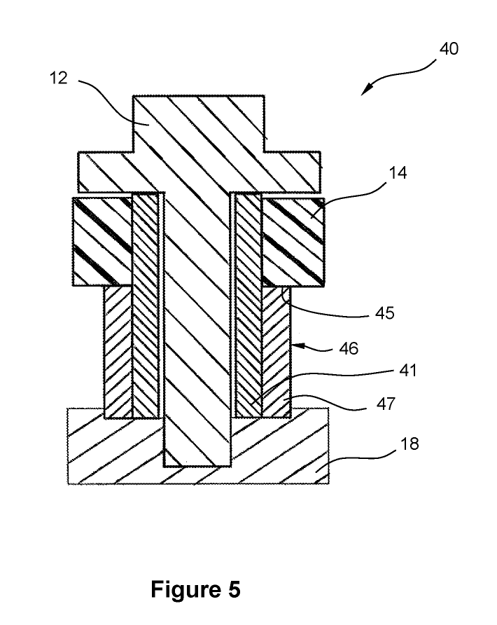

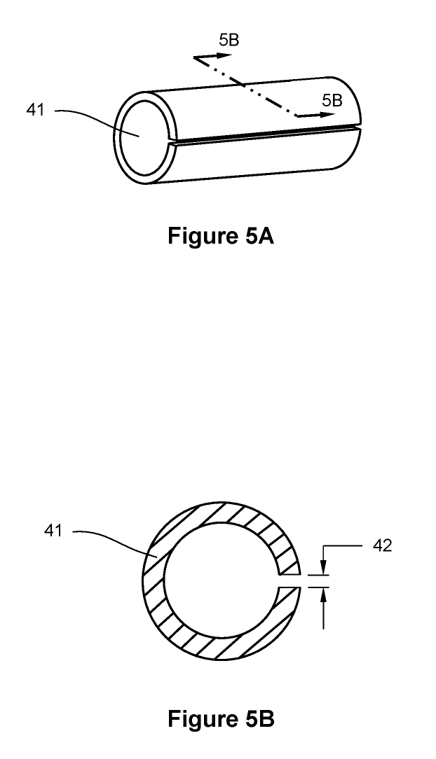

FIG. 5 shows a coolant valve mounting arrangement 40 with a compression limiter 46 that contains a male element 41 that is inserted in a female element 47. The female element 47 is shorter than the male element 41, such that a first portion is formed from the extending male portion and a second portion is formed from the female portion. One end of the female element 47 is coplanar with one end of the male element 41 and abuts with the mounting base 18, while the other end of the female element forms a shelf 45 that supports the housing 14. Referring now to FIGS. 5A and 5B, optionally a through slit 42 exists along the length of the male segment 41 to add an elastic characteristic which enables ease of installation of the female segment 47.

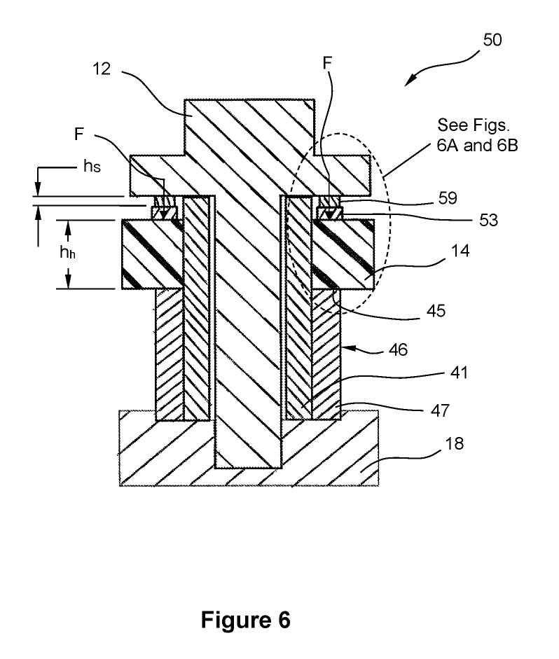

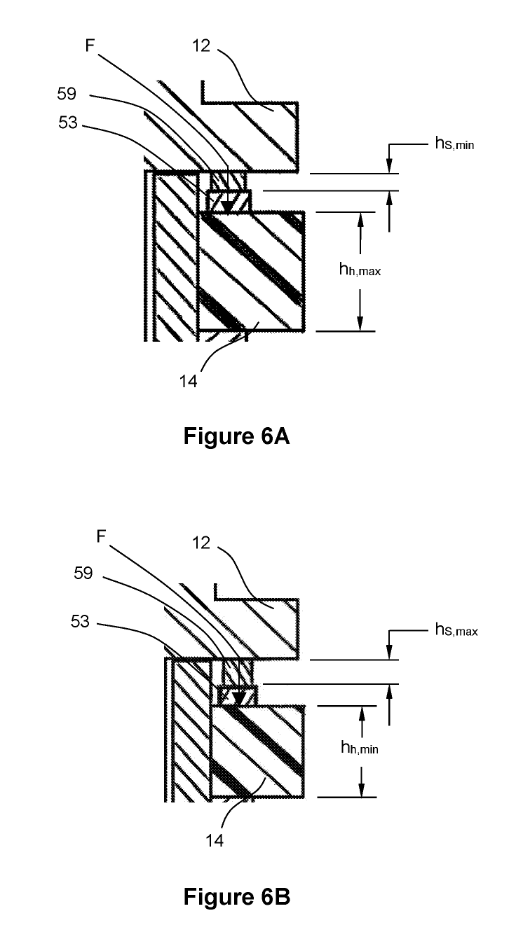

FIG. 6 shows a coolant valve mounting arrangement 50 that adds an optional spring washer 59 with a spring constant k that imparts a force F on the housing 14 through an optional support washer 53. The addition of the spring washer 59 ensures that the force F is applied to the housing 14 for all housing and compression limiter size variations and coolant valve mounting arrangement operating temperatures. The spring washer 59 can be of various types including split type, Belleville type or wave type.

The addition of the support washer 53 ensures that the spring washer 59 can function as intended without harming, deforming or inducing unwanted stresses in the housing 14. Housing 14 height hₕ and spring washer 59 height hₛ are shown in FIG. 6. Housing 14 height hₕ and spring washer 59 height hₛ both vary with the coolant valve mounting arrangement operating temperature. As operating temperature increases, housing 14 height hₕ increases due to thermal expansion, causing spring washer 59 height hₛ to decrease. Due to the spring constant k of the spring washer 59, the force imparted on the housing through support washer 53 increases as spring washer 59 height hₛ decreases. As operating temperature decreases, housing 14 height hₕ decreases due to thermal contraction, causing spring washer 59 height hₛ to increase. Due to the spring constant k of the spring washer 59, the force imparted on the housing through support washer 53 decreases as spring washer 59 height hₛ increases. The design of the spring washer 59 must be such that the force F applied by the spring washer 59 to the housing 14 when the spring washer 59 is at its maximum height (minimum temperature condition), is adequate for sealing while not overstressing the housing 14 material when at its minimum height (maximum temperature condition). The support washer 53 is made from metal, and given its smaller height and lower coefficient of thermal expansion in comparison with the typically plastic housing 14, it has been ignored in the above discussion, although it would also have some minimal effect. FIGS. 6A and 6B show detailed views of the coolant valve mounting arrangement of FIG. 6 at the maximum and minimum operating temperature conditions. Referring to FIG. 6A, which represents a maximum operating temperature condition, a maximum housing thickness due to thermal expansion is shown as h_{h,max}, in addition to a resultant spring washer 59 height h_{s,min}. Now referring to FIG. 6B, which represents a minimum operating temperature condition, a minimum housing thickness due to thermal contraction is shown as h_{h,min}, in addition to a resultant spring washer height h_{s,max}.

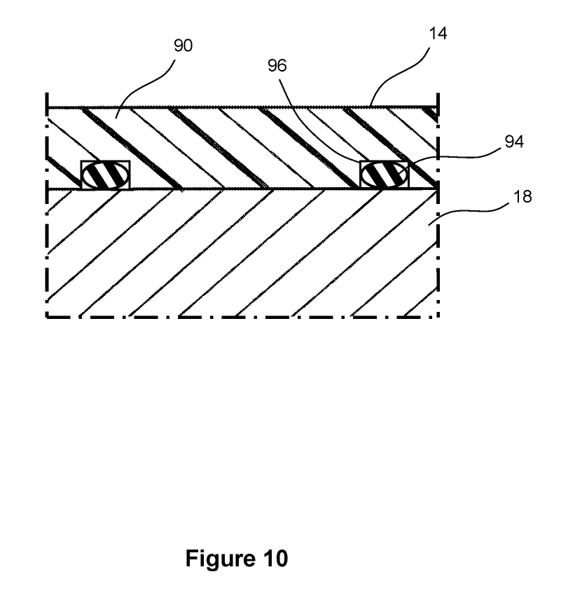

Referring to FIG. 10, which shows a portion 90 of the housing 14 and the mounting base 18 away from a fastening location, housing portion 90 contains an optional groove 96 for an optional seal 94. The seal 94 can be of many forms, such as an O-ring or a press-in-place (PIP) gasket. The application of a load to the housing portion 90 causes compression of the seal 94 against the mounting base 18, thus providing a leak-proof interface. Referring again to FIG. 6B, the optional spring washer 59 is preferably designed to ensure that the force F applied to the housing 14 through support washer 53 is enough to facilitate a leak-proof interface between the housing 14 and the mounting base 18 during a minimum operating temperature condition when the spring washer 59 is at its greatest height h_{s,max}. In addition, referring again to FIG. 6A, for all size conditions, the maximum force imparted on the housing 14 by the spring washer 59 via support washer 53 at its minimum height condition h_{s,min} should not exceed the yield stress of the housing 14. This relationship can be characterized by the following equation:

$$\frac{{F}_{preload} + k ( {h}_{s , max} - {h}_{s , min} )}{{A}_{2 nd disc}} \leq {σ}_{y , housing}$$

where:

F_{preload}=force applied to the coolant valve housing 14 by the resilient disc (spring washer 59) at a minimum operating temperature and;

k=spring constant of the first resilient disc (spring washer 59);

h_{s,max}=height of the first resilient disc (spring washer 59) at the minimum operating temperature of the mounting arrangement;

h_{s,min}=height of the first resilient disc (spring washer 59) at the maximum operating temperature of the mounting arrangement;

A_{2nd disc}=minimum contact area of the second disc (support washer 53) with the housing;

σ_{y,housing}=yield strength of the housing 14.

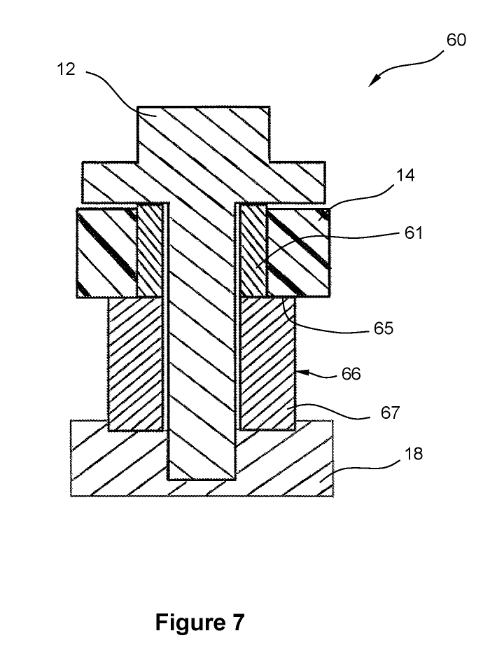

FIG. 7 shows a coolant valve mounting arrangement 60 with a compression limiter 66 with a first or upper element 61 that abuts against a second or lower element 67. A shelf 65 is formed at the abutment location of these two elements.

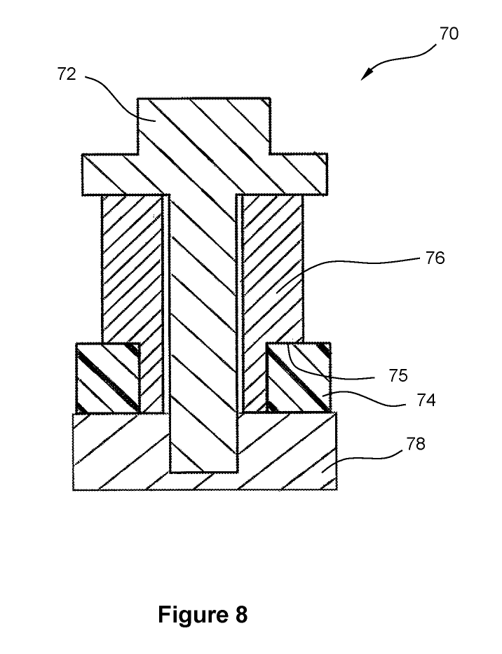

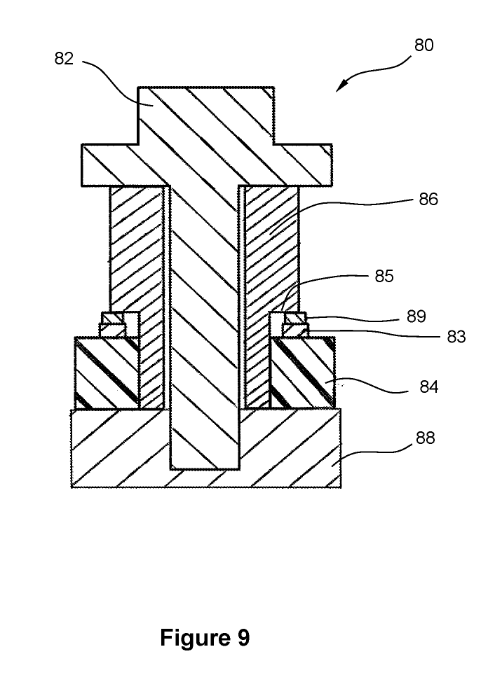

FIG. 8 shows a second embodiment of a coolant valve mounting arrangement 70 with a fastener 72, a housing 74 of the coolant valve, a compression limiter 76, and a mounting base 78. The compression limiter 76 contains a shelf 75 to support the housing 74. However, compared to the first embodiment shown in FIGS. 2-7, the housing 74 is located at the opposite end of the compression limiter 76 and directly interfaces with the mounting base 78. Depending on the design of the coolant valve attachment points, which greatly depends on the loading and packaging requirements, this embodiment could prove more favorable in some application environments.

FIG. 9 shows a coolant valve mounting arrangement 80 that is a variant of the second embodiment shown in FIG. 8. This variant includes a fastener 82, a housing 84 of the coolant valve, a compression limiter 86 and a mounting base 88. The compression limiter 86 includes a shelf 85 that interfaces with a spring washer 89 that transmits a force to the housing through support washer 83. The addition of spring washer 89 ensures that a force is maintained on the housing 84 for all size variations and operating temperatures in order to maintain a leak-free interface with the mounting base 88. The presence of the support washer ensures proper function of the spring washer 89, without harming, deforming or inducing stresses on the surface of the housing 84. While here the housing 84 is arranged against the mounting base 88, the same force relationship as previously described would also be applicable based on the changes of the housing height and spring washer height due to thermal expansion and contraction.

As in the first embodiment and respective variations shown in FIGS. 2-7, both of the coolant valve mounting arrangements 70, 80 shown in FIGS. 8 and 9 will likely result in a lower thermal stress condition than the coolant valve mounting arrangement 100 shown in FIG. 1A due to the reduced housing height.

For a given coolant valve that contains multiple attachment points, typically three or more, there may be a mixture of mounting arrangements with some as shown in FIGS. 2-7 and others as shown in FIGS. 8-9.

Having thus described various embodiments of the present coolant valve mounting arrangement in detail, it is to be appreciated and will be apparent to those skilled in the art that many physical changes, only a few of which are exemplified in the detailed description above, could be made in the apparatus without altering the inventive concepts and principles embodied therein. The present embodiments are therefore to be considered in all respects as illustrative and not restrictive, the scope of the invention being indicated by the appended claims rather than by the foregoing description, and all changes which come within the meaning and range of equivalency of the claims are therefore to be embraced therein.

What is claimed is:

1. A coolant valve mounting arrangement comprising:
a housing with a through aperture;
a mounting base; and
a compression limiter with a through hole defined therethrough, axially aligned with the through aperture, the compression limiter comprising:
a first portion with an outer surface disposed within the through aperture of the housing and a second portion forming a shelf at a medial position on the compression limiter that supports the housing; and
a fastener that extends through the through hole of the compression limiter and attached to the mounting base.

2. The coolant valve mounting arrangement of claim 1, wherein the shelf of the compression limiter supports a first side of the housing.

3. The coolant valve mounting arrangement of claim 1, wherein the first portion and the second portion of the compression limiter have an outer surface that is round.

4. The coolant valve mounting arrangement of claim 1, further comprising a disc disposed on the shelf of the compression limiter with an outer diameter of the disc protruding outwardly from the shelf with a first side in contact with the first side of the housing.

5. The coolant valve mounting arrangement of claim 1, wherein the compression limiter comprises a male element of a first length disposed within a female element of a second length, the second length is shorter than the first length, the first portion being formed by a length of the male element that extends from the female element, the second portion being formed by the female element such that a first side of the female element forms the shelf, and a second side is coplanar with a first side of the male element, abutting with the mounting base.

6. The coolant valve mounting arrangement of claim 5, wherein the male element has a through slit along the first length.

7. The coolant valve mounting arrangement of claim 5, further comprising:
a first resilient disc disposed around an outer surface of the male element; and
a second disc disposed around the outer surface of the male element with a first side in contact with a first side of the first resilient disc and a second side in contact with a second side of the housing.

8. The coolant valve mounting arrangement of claim 7, wherein in a first temperature state of the housing, the first resilient disc is compressed to a first height, and in a second temperature state, the first resilient disc is compressed to a second height that is less than the first height.

9. The coolant valve mounting arrangement of claim 8, wherein a force of the first resilient disc is satisfied by the following equation:
$$\frac{{F}_{preload} + k ( {h}_{s , max} - {h}_{s , min} )}{{A}_{2 nd disc}} \leq {σ}_{y , housing}$$
where:
F_{preload}=force applied to the coolant valve housing by the first resilient disc at a minimum operating temperature;
k=spring constant of the first resilient disc;
h_{s,max}=height of the first resilient disc at a minimum operating temperature of the coolant valve mounting arrangement;
h_{s,min}=height of the first resilient disc at a maximum operating temperature of the coolant valve mounting arrangement;
Δ_{2nd disc}=minimum area of the second disc that interfaces with the coolant valve housing;
σ_{y,housing}=yield strength of the housing.

10. The coolant valve mounting arrangement of claim 1, wherein the compression limiter further comprises:
a first element disposed within the through aperture of the housing; and
a second element having:
a first side that abuts with a first side of the first element; and
an outwardly extending portion that forms the shelf.

11. The coolant valve mounting arrangement of claim 1, wherein the shelf of the compression limiter is in contact with a second side of the housing.

12. The coolant valve mounting arrangement of claim 11, further comprising:
a first resilient disc with a first side in contact with the shelf of the compression limiter; and
a second disc with a first side in contact with a second side of the first resilient disc and a second side in contact with the second side of the housing.

13. The coolant valve mounting arrangement of claim 1, wherein the fastener includes an integral flange.

14. The coolant valve mounting arrangement of claim 1, further comprising a washer with a first side in contact with a head of the fastener.

15. The coolant valve mounting arrangement of claim 1, wherein the housing is made from plastic.

16. The coolant valve mounting arrangement of claim 15, wherein the plastic is over-molded on the compression limiter.

17. The coolant valve mounting arrangement of claim 1, wherein the mounting base has a recess to receive the compression limiter.

18. The coolant valve mounting arrangement of claim 1, wherein a first side of the compression limiter is in contact with the mounting base.

19. The coolant valve mounting arrangement of claim 1, wherein the compression limiter is made of metal.

20. The coolant valve mounting arrangement of claim 11, wherein the first resilient disc is selected from a group consisting of a split type, Belleville type or wave type.
